(19) United States
(12) Patent Application Publication
(10) Pub. No.: US 2018/0232720 A1
(43) Pub. Date: Aug. 16, 2018

(54) SYSTEM AND METHOD FOR PROCESSING A MULTI-ACCOUNT TRANSACTION

(71) Applicant: MasterCard International Incorporated, Purchase, NY (US)

(72) Inventors: Erica Joann Robeen, Hardin, IL (US); Rick Unnerstall, O'Fallon, MO (US); Linda M. Mautz, O'Fallon, MO (US)

(21) Appl. No.: 15/429,667

(22) Filed: Feb. 10, 2017

(51) Int. Cl. G06Q 20/22; G06Q 20/40; G06Q 20/34

(52) U.S. Cl. CPC G06Q 20/29; G06Q 20/351; G06Q 20/40

(57) ABSTRACT

A multi-account payment card (MPC) transaction computing device is configured to receive a first and second transaction request, wherein each transaction request includes a payment card account identifier and a portion of a payment transaction with a merchant to be paid using the payment card account. The MPC transaction computing device then generates a virtual card number (VCN) and transmits the VCN to a user computing device. The MPC transaction computing device further facilitates authorization of the payment transaction by separately conduction authorization for the first payment card account corresponding to the first transaction request and the second payment card account for the second portion of the payment transaction. The MPC transaction computing device then generates a VCN authorization confirmation message and transmits the VCN authorization confirmation message to the merchant.

### BACKGROUND

The field of the invention relates to electronic payment card transactions, and, in particular, to transactions in which multiple accounts are used to fund a purchase.

Groups of consumers are often presented with purchasing situations in which each member of the group is required to pay for a portion of a purchase. One very common situation is when a group goes to a restaurant and shares a meal and drinks. In certain instances, the restaurant/merchant may not be able to or willing to generate individual bills for each consumer and, as a result, one consumer generally pays for the meal under the assumption that he or she will be reimbursed by the other members of the group. Settling up between the payee and the individual group members is generally unreliable and usually involves one or more of a cash exchange, later settlement through electronic payment transfers, or a later promise that the group member will pay back the payee in kind. These issues are further exacerbated when the group members are not in close proximity. For example, if a group of friends dispersed across the country wish to split a gift purchase for another friend, they must generally rely on one of them to make the purchase on behalf of the group on the promise of later reimbursement.

Individual consumers may also encounter purchasing situations in which they want to pay using multiple funding sources or accounts including, without limitations, one or more credit card accounts and bank accounts. For example, an individual consumer may want to split a purchase for various reasons including, without limitation, avoiding maxing out a credit limit, avoiding overdrawing a bank account, earning purchasing rewards, and the like.

The ubiquity of multi-account purchasing situations renders known systems in which a consumer or group of consumers are limited to paying using a single payment card account undesirable. For example, such known systems are inconvenient and lead to consumer dissatisfaction because consumers are unable to pay for a purchase as they wish. Transaction time may also be increased as consumers try to negotiate or otherwise determine how to fund the purchase and ensure that the payee is adequately reimbursed. In some cases, consumers may completely forego a purchase due to their dissatisfaction or because they are unable to make the purchase without relying on multiple funding sources.

In light of the foregoing, a system and method for facilitating multi-account purchases is needed that resolves the inefficiencies and inconvenience of known single payment account systems.

### BRIEF DESCRIPTION OF THE DISCLOSURE

In one aspect, a multi-account payment card (MPC) transaction computing device is provided. The MPC transaction computing device includes one or more processors in communication with one or more memory devices, and is configured to receive a first transaction request and a second transaction request. The first transaction request includes a first identifier corresponding to a first payment card account and a first portion of a payment transaction with a merchant to be paid using the first payment card account. Similarly, the second transaction request includes a second identifier corresponding to a second payment card account and a second portion of the payment transaction to be paid using the second payment card account. In response to receiving the transaction requests, the MPC transaction computing device generates a virtual card number (VCN) corresponding to the payment transaction and a VCN record correlating the VCN to each of the first payment card account and the second payment card account. The MPC transaction computing device then transmits the VCN to a user computing device of an accountholder of one of the first payment card account and the second payment card account. The MPC transaction computing device is further configured to authorize the payment transaction by authorizing the first payment card account for the first portion of the payment transaction and authorizing the second payment card account for the second portion of the payment transaction. Following authorization, the MPC transaction computing device generates a VCN authorization confirmation message and transmits the VCN authorization confirmation message to the merchant.

In another aspect, a computer-implemented method for processing a multi-account payment card (MPC) transaction is provided. The method is implemented by a MPC transaction computing device and includes receiving, at the MPC transaction computing device, each of a first transaction request and a second transaction request. The first transaction request includes a first identifier corresponding to a first payment card account and a first portion of a payment transaction with a merchant to be paid using the first payment card account. Similarly, the second transaction request includes a second identifier corresponding to a second payment card account and a second portion of the payment transaction to be paid using the second payment card account. The method further includes generating a virtual card number (VCN) corresponding to the payment transaction, wherein generating the VCN includes generating a VCN record correlating the VCN to each of the first payment card account and the second payment card account and transmitting the VCN to a user computing device of an accountholder of one of the first payment card account and the second payment card account. The method further includes authorizing the payment transaction, wherein authorizing the payment transaction includes authorizing the first payment card account for the first portion of the payment transaction and authorizing the second payment card account for the second portion of the payment transaction. The method also includes generating a VCN authorization confirmation message and transmitting the VCN authorization confirmation message to the merchant.

In another aspect, a non-transitory computer-readable storage media including computer executable instructions for facilitating processing of multi-account payment card (MPC) transactions is provided. When executed by a MPC transaction computing device, the computer-executable instructions cause the MPC transaction computing device to receive a first transaction request and a second transaction request. The first transaction request includes a first identifier corresponding to a first payment card account and a first portion of a payment transaction with a merchant to be paid using the first payment card account. Similarly, the second transaction request includes a second identifier corresponding to a second payment card account and a second portion of the payment transaction to be paid using the second payment card account. The computer executable instructions further cause the MPC transaction computing device, in response to receiving the transaction requests, to generate a virtual card number (VCN) corresponding to the payment transaction and a VCN record correlating the VCN to each of the first payment card account and the second payment card account. The computer executable instructions cause the MPC transaction computing device to transmit the VCN to a user computing device of an accountholder of one of the first payment card account and the second payment card account. The computer executable instructions also cause the MPC transaction computing device to authorize the payment transaction by authorizing the first payment card account for the first portion of the payment transaction and authorizing the second payment card account for the second portion of the payment transaction. Following authorization, the computer executable instructions cause the MPC transaction computing device to generate a VCN authorization confirmation message and to transmit the VCN authorization confirmation message to the merchant.

### BRIEF DESCRIPTION OF THE DRAWINGS

FIG. 1 is a schematic diagram illustrating a multi-account payment card (MPC) transaction system for performing multi-account payment card transactions;

FIG. 2 is a schematic diagram illustrating a second (MPC) transaction system for performing multi-account payment card transactions;

FIG. 3 is a schematic illustration of a MPC transaction computing device for use in the MPC transaction systems of FIGS. 1 and 2;

FIG. 4 is a schematic illustration of a user computer device for use in the MPC transaction systems of FIGS. 1 and 2;

FIG. 5 is a diagram illustrating an example method for processing an MPC transaction performed by an MPC transaction computing device, such as the MPC transaction computing device of FIG. 3;

FIG. 6 is a diagram illustrating an example method for clearing an MPC transaction performed by an MPC transaction computing device, such as MPC transaction computing device of FIG. 3; and

FIG. 7 is a diagram illustrating an example method for settling an MPC transaction performed by an MPC transaction computing device, such as MPC transaction computing device of FIG. 3.

### DETAILED DESCRIPTION OF THE DISCLOSURE

Embodiments of the present invention relate generally to a multi-account payment computing system for processing multi-account payment card transactions. As used herein, the term “multi-account payment card transaction” or “MPC transaction” is used to refer to a payment card transaction in which one or more cardholders pays for a transaction using more than one payment card account. Accordingly, an MPC transaction may refer to transactions in which a single cardholder makes a purchase using multiple payment card accounts (referred to herein as a “single user MPC transaction”) and to transactions in which each cardholder of a group of cardholders pays for a transaction using one or more payment card accounts (referred to herein as a “multi-party MPC transaction”).

As described herein, the MPC transaction computing systems enable MPC transactions by facilitating the necessary exchange of transaction data between parties to the MPC transaction. More specifically, an MPC transaction computing device of an MPC transaction computing system enables merchants and acquiring banks to treat MPC transactions as if they were single-account payment card transactions. The MPC transaction computing device further ensures that authorization, settlement, clearance, and any associated processing of the MPC transaction is conducted such that each individual payment card account used in the MPC transaction is properly authorized and charged for its respective amount of the MPC transaction. For example, an MPC transaction by individuals A, B, and C for $60 divided evenly between A, B, and C requires that the payment accounts of each of A, B, and C be authorized and charged for $20. For purposes of this disclosure, the individual transactions involved in an MPC transaction are referred to herein as “subtransactions” of the MPC transaction.

In the example embodiments, the MPC transaction computing device receives two or more transaction request messages corresponding to an MPC transaction, each transaction request message including an identifier corresponding to a payment card account and an amount to be charged to the payment card account. In response, the MPC transaction computing device generates a virtual card number (VCN) for use in the MPC transaction and transmits the VCN to a user computing device associated with one of the payment card accounts. The merchant then uses the VCN as if it were a payment card number to process the MPC transaction. To facilitate processing of the MPC and the underlying subtransactions, the MPC transaction computing device generates a VCN record correlating the VCN to the payment card accounts used in the MPC transaction.

The MPC transaction computing device generally coordinates the authorization, clearing, and settlement process for a given MPC transaction. More specifically, the MPC transaction computing device facilitates authorization, clearing, and settlement (each of which is discussed in more detail below) for each subtransaction of the MPC transaction. During authorization, the MPC transaction computing device receives a single authorization request from a merchant or acquiring bank including a VCN. Accordingly, MPC transaction computing device generates individual authorization request messages for each payment card account used in the VCN and transmits each authorization request message to a respective issuing bank for authorization. Similarly, during clearing, the MPC transaction computing device receives a single clearing request from an acquiring bank including a VCN. The MPC transaction computing device then generates individual clearing messages for each payment card account used in the VCN and transmits each clearing message to a respective issuing bank such that the payment card account may be properly charged. During settlement, the MPC transaction computing device receives and consolidates fund transfer from each issuing bank and consolidates them into a single fund transfer to the acquiring bank using the VCN.

As previously noted, an MPC transaction may be a multi-party transaction in which multiple individuals are paying for a purchase. Accordingly, in certain embodiments, MPC transactions include a payment coordination process in which parties are associated with a particular purchase. The payment coordination process generally includes identifying parties to a transaction and receiving confirmation that the parties wish to participate in the transaction. The payment coordination process generally includes the exchange of coordination data between user computing devices in order to coordinate the MPC transaction and may include, without limitation, exchanging security tokens, generation and transmission of messages (such as emails, SMS and text messages), exchanging haptic input data, exchanging accelerometer data, and the like.

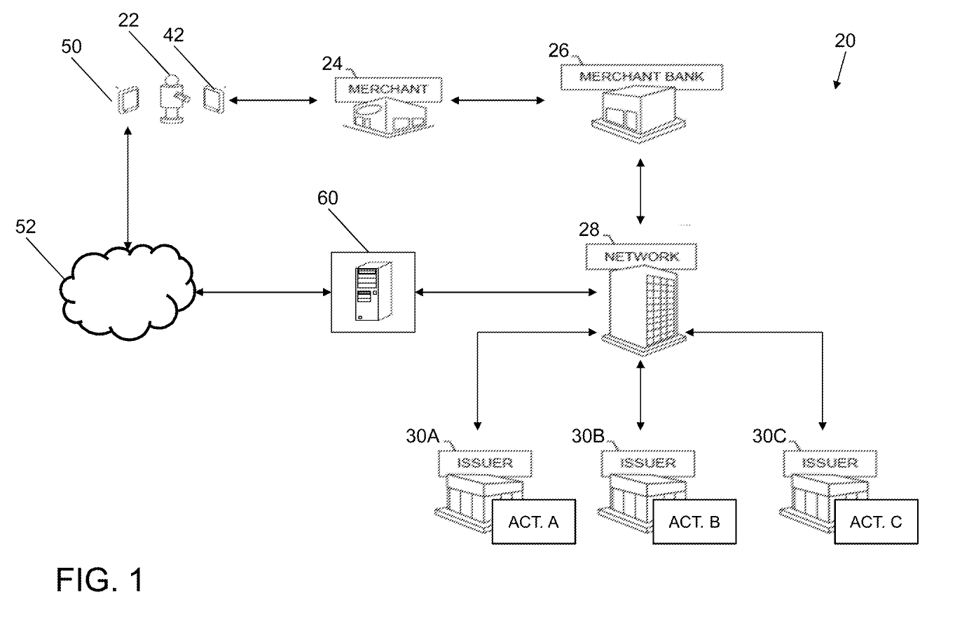

FIG. 1 is a schematic diagram illustrating a multi-account payment card (MPC) transaction system 20 for performing multi-account payment card transactions. Embodiments described herein may relate to a payment card transaction system, such as a payment card transaction system using the MasterCard® interchange network. The MasterCard® interchange network is a set of proprietary communications standards promulgated by MasterCard International Incorporated for the exchange of financial transaction data and the settlement of funds between financial institutions that are associated with MasterCard International Incorporated. (MasterCard is a registered trademark of MasterCard International Incorporated located in Purchase, N.Y.).

FIG. 1 shows an operation of payment card industry system 20 in the context of processing a single user multi-account payment card (“MPC”) transaction. In a single user MPC transaction, a single user makes a payment using multiple payment card accounts.

In a typical transaction card system, a financial institution referred to as an “issuer” issues a payment card, such as a credit card, debit card, and the like, to an accountholder 22, who is then able to use the payment card to tender payment for a purchase from a merchant 24. In the context of a single user MPC transaction, accountholder 22 holds multiple payment card accounts. In the embodiment of FIG. 1, accountholder 22 holds three payment card accounts, one with each of issuers 30A, 30B, and 30C. In other embodiments, accountholder 22 holds two or more payment card accounts with any number of issuers. Accordingly, accountholder 22 may hold multiple payment card accounts with a single issuer or may hold multiple payment card accounts across multiple issuers, each issuer providing at least one payment card account.

To accept payment with the payment card, merchant 24 normally establishes an account with a financial institution that is part of the financial payment system. This financial institution is referred to as the “merchant bank,” the “acquiring bank,” or the “acquirer.” In single payment account transactions, accountholder 22 tenders payment for a purchase using a payment card at a transaction processing device 42 (e.g., a point of sale device or via a merchant website) and merchant 24 then requests authorization from a merchant bank 26 for the amount of the purchase. The request can be performed through the use of a point-of-sale terminal, which reads account information from a magnetic stripe, a chip, embossed characters, and the like, included on the payment card of accountholder 22 and communicates electronically with the transaction processing computers of merchant bank 26. In the case of online purchases, telephone purchases, and similar transactions in which accountholder 22 does not physically present a card, accountholder 22 provides an identifier, such as a payment card account number, which is then submitted by merchant 24 for processing. In such transactions, accountholder 22 may also provide additional information such as a billing zip code, a personal identification number (PIN), or a card security code to verify accountholder 22. In certain embodiments, merchant bank 26 authorizes a third party to perform transaction processing on its behalf. In this case, the point-of-sale terminal may be configured to communicate with the third party. Such a third party may be referred to as a “merchant processor,” an “acquiring processor,” or a “third party processor.”

Using an interchange network 28, computers of merchant bank 26 or merchant processor communicate with computers of an issuer bank, such as issuer banks 30A-C, to determine whether accounts of accountholder 22 are in good standing and whether the purchase is covered by an available credit line of the accounts, i.e., is declined or accepted. If the request is accepted, an authorization response message is issued to merchant 24. The authorization response message often includes an authorization code indicated that the payment transaction has been authorized.

In single user MPC transactions in accordance with the present disclosure, accountholder 22 submits two or more transaction requests, each of which corresponding to a particular payment card account and an amount to be charged thereto. In certain embodiments, the transaction requests are consolidated into a single transaction request message. For example, in certain embodiments, accountholder 22 operates an application on a user computing device 50 that permits accountholder 22 to initiate MPC transactions. The application facilitates such transactions by allowing accountholder 22 to enter an amount of the payment card transaction, select two or more of his or her payment card accounts to be used for the payment, and provide the amount to be charged to each of the payment card accounts. The application then generates a transaction request message including transaction requests for each payment card account to be used and transmits the transaction request message to an MPC transaction computing device 60 over a network 52, such as the Internet. In response to receiving the transaction request message, MPC transaction computing device 60 generates a virtual card number (VCN) representing the collection of payment card accounts of the transaction request message. MPC transaction computing device 60 further generates a VCN record correlating the VCN with the underlying payment card accounts. MPC transaction computing device 60 then transmits the VCN to user computing device 50. Accountholder 22 provides the VCN to merchant 24 and merchant 24 then submits the payment transaction using the VCN as normally done in a single payment account transaction. MPC transaction computing device 60 is shown in FIG. 1 as a separate computing device communicatively coupled to interchange network 28 and network 52. In other embodiments, MPC transaction computing device 60 is integrated into interchange network 28.

Authorization of MPC transactions requires that each subtransaction of the MPC transaction be separately authorized. That is, each payment card account included in the MPC transaction is required to be authorized for its corresponding portion of the MPC transaction. In certain embodiments, each subtransaction is pre-authorized. More specifically, when accountholder 22 submits a transaction request message, MPC transaction computing device 60 generates individual authorization requests corresponding to each transaction request of the transaction request message. MPC transaction computing device 60 submits each authorization request to the corresponding issuer 30A-C for authorization. When MPC transaction computing device 60 receives authorization response messages from each issuer indicating that each subtransaction is authorized, MPC transaction computing device 60 generates and transmits the VCN to user computing device 50. If a positive authorization response message is not received for each subtransaction, MPC transaction computing device 60 does not generate a VCN and notifies accountholder 22 via user computing device 50 that the MPC transaction has been declined. If the MPC transaction is authorized and merchant 24 submits a payment transaction using the VCN for authorization, MPC transaction computing device 60 automatically sends an authorization response message to merchant 24 in light of the positive pre-authorization.

In alternative embodiments, authorization occurs when merchant 24 submits for authorization a payment card transaction using the VCN. In such embodiments, MPC transaction computing device 60 generates individual authorization requests corresponding to each payment card account represented by the VCN. MPC transaction computing device 60 submits each authorization request to the corresponding issuer 30A-C for authorization. When MPC transaction computing device 60 receives authorization response messages from each issuer indicating that each subtransaction is authorized, MPC transaction computing device 60 generates a consolidated authorization response message and transmits the consolidated authorization response message to merchant 24. If an authorization response message is not received from any issuer corresponding to a subtransaction, MPC transaction computing device 60 generates a consolidated response message indicating that the transaction is declined.

Following authorization, the available credit line of the accountholder 22 is decreased. In the case of MPC transactions, the available credit line for each payment card account represented by the VCN is decreased. For example, in MPC transaction system 20, each of accounts A, B, and C, which are maintained by issuer 30A, 30B, and 30C, respectively, are each decreased according to the division of the MPC transaction. In certain embodiments, charges for a payment card transaction are not posted immediately to the account of accountholder 22. For example, payment networks, such as MasterCard International Incorporated, may apply rules that do not allow merchant 24 to charge, or “capture,” a transaction until goods are shipped or services are delivered. As another example, in the case of MPC transactions in which pre-authorization occurs, charges for a payment card transaction may only be posted after merchant 24 submits a payment transaction using the VCN. As a result, payment card accounts involved in the MPC are not prematurely charged. With respect to at least some payment card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If accountholder 22 cancels a transaction before it is captured, a “void” is generated. If accountholder 22 returns goods after capture of the transaction, a “chargeback” is generated. Interchange network 28 and/or issuer banks 30A-C store the payment card information, such as a type of merchant, amount of purchase, date of purchase, in a database.

After a purchase has been made, a clearing process occurs to transfer additional transaction data related to the purchase among the parties to the transaction, such as merchant bank 26, interchange network 28, and issuer banks 30A-C. During the clearing process, additional data (i.e., addendum data), may be added to the transaction data. Accordingly, addendum data may be associated with a transaction and transmitted between parties to the transaction as transaction data, and may be stored by any of the parties to the transaction.

The clearing process generally includes acquirer or merchant bank 26 submitting a clearing request to interchange network 28. The clearing request generally includes transaction data. In single payment card account transactions, interchange network 28 forwards the transaction data to the appropriate issuer. However, in the case of MPC transactions, individual clearing messages must be sent to each issuer corresponding to each payment account used in the MPC transaction. Accordingly, when a clearing request is received from merchant bank 26, MPC transaction computing device 60 generates individual clearing messages corresponding to each issuer implicated by the MPC transaction. Each clearing message includes only the relevant transaction data for the particular issuer to which it is being sent.

After a transaction is authorized and cleared, the transaction is settled among merchant 24, merchant bank 26, and an issuer bank. Settlement generally refers to the transfer of financial data or funds among an account of merchant 24, merchant bank 26, and an issuer bank. Usually, transactions are captured and accumulated into a “batch,” which is settled as a group. More specifically, a transaction is typically settled between the issuer bank and interchange network 28, and then between interchange network 28 and merchant bank 26, and then between merchant bank 26 and merchant 24.

Settlement of an MPC transaction similarly involves settlement of each subtransaction between the corresponding issuer bank, i.e., one of issuer 30A, 30B, and 30C, and interchange network 28. However, subsequent settlement between interchange network 28 and merchant bank 26 and between merchant bank 26 and merchant 24 is based on a single payment transaction using the VCN. Accordingly, MPC transaction computing device 60 facilitates settlement of the MPC transaction by consolidating the fund transfers and settlement messages of each subtransaction of the MPC transaction into a single fund transfer and settlement message.

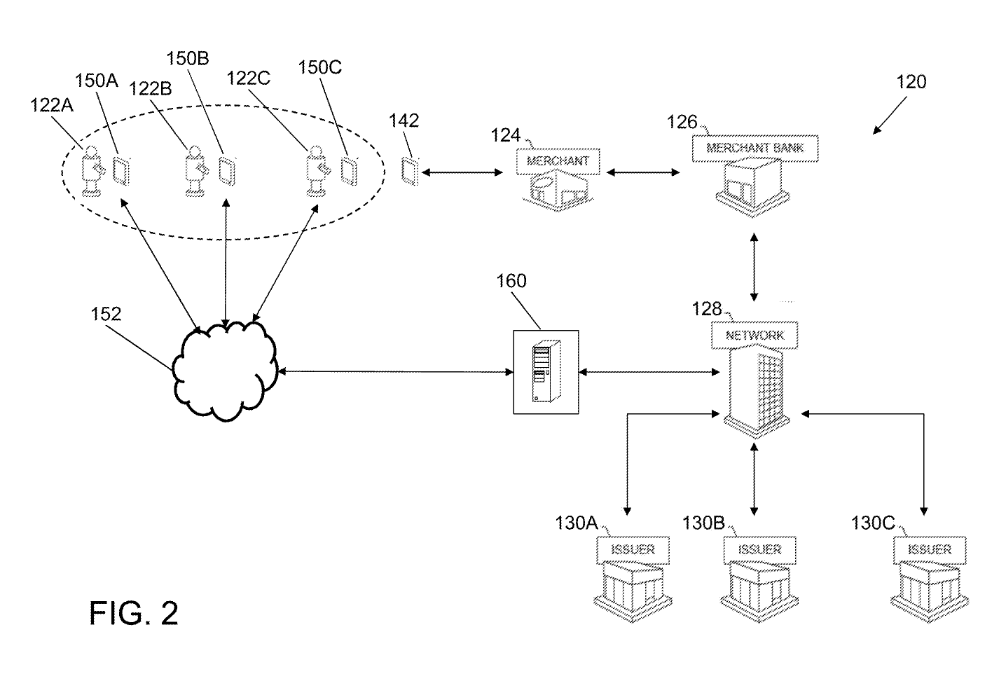

FIG. 2 is a schematic diagram illustrating a second multi-account payment card (MPC) transaction system 120 for performing multi-account payment card transactions. In contrast to MPC transaction system 20 of FIG. 1, MPC transaction system 120 is directed to processing multi-party MPC transactions. Multi-party MPC transactions involve payments by multiple accountholders, each of which pays with one or more payment card accounts. For simplicity, MPC transaction system 120 includes three accountholders 122A, 122B, and 122C. Accountholders 122A, 122B, and 122C hold a single payment card account with issuers 130A, 130B, and 130C, respectively. In other embodiments, more or fewer accountholders may be participants in an MPC transaction. Similarly, each accountholder in an MPC transaction may pay using multiple payment card accounts.

A multi-party MPC transaction is generally a transaction in which multiple accountholders pay for separate portions of one payment transaction. In general, a multi-party MPC transaction is initiated by an accountholder and additional accountholders are added to or otherwise join the multi-party MPC transaction, as discussed in more detail below. For purposes of the following discussion, accountholder 122A is the initiator of a multi-party MPC transaction while accountholders 122B and 122C are additional participants in the multi-party MPC transaction.

To initiate a multi-party MPC transaction, accountholder 122A opens an MPC transaction application or similar program on a user computing device 150A. The application permits accountholder 122A to create a multi-party MPC transaction that others may join. Creation of the multi-party MPC transaction generally includes specifying a total amount of the transaction. In certain embodiments, creation may further include specifying additional identifying information for the multi-party MPC transaction including, without limitation, a description of the product/service purchased, a date/time of the purchase, a location of the purchase, and a note with additional information provided by accountholder 122A. In certain embodiments, the application permits accountholder 122A to take a photo of or otherwise scan a receipt or bill that automatically populates the details of the multi-party payment card transaction based on the scanned image. In still other embodiments, the application permits user computing device 150A to read barcodes, quick response (QR) codes, or similarly encoded data corresponding to the transaction that is printed on a receipt or otherwise made available by merchant 124. In still other embodiments, user computing device 150A communicates with a computing device of merchant 124, such as point-of-sale terminal 142, to acquire any data required to create the multi-party MPC transaction. In certain embodiments, creating a multi-party MPC transaction includes assignment of an MPC transaction name or identifier that may be used to identify the particular multi-party MPC transaction.

After a multi-party MPC transaction is created, accountholders 122B and 122C can join or be added to the multi-party MPC transaction. In certain embodiments, the process of adding accountholders is initiated by the accountholder who created the multi-party MPC transaction. For example, in certain embodiments, accountholder 122A transmits a short message service (SMS) message, text message, email, or similar message to user computing devices 150B and 150C of accountholders 122B and 122C, respectively. Accountholders 122B and 122C then accept the request by opening the message, executing a link within the message, replying to the message, and the like. In certain embodiments, accountholders 122B and 122C also operate an MPC transaction application on user computing devices 150B and 150C and the request message from accountholder 122A is in the form of an in-application message or notification.

In other embodiments, accountholders 122B and 122C are added to the multi-party MPC transaction by a data exchange between user computing devices 150A, 150B, and 150C over a short range communication protocol such as, without limitation, one of Bluetooth and near-field communication (NFC). For example, in one embodiment, accountholder 122A uses the MPC transaction application to generate a data token containing details of the payment transaction and sends the data token (by placing in close proximity to other devices) to each of user computing devices 150B and 150C. When accountholders 122B and 122C confirm participation in the multi-party MPC transaction, a similar token is returned to user computing device 150A indicating the confirmation. In a second embodiment, the data exchanged over the short range communication protocol corresponds to input data received by user computing devices 150B and 150C from accountholders 122B and 122C, respectively. For example, during creation of the multi-party MPC transaction, accountholder 122A may specify a particular touchscreen input pattern required to join the transaction. Accordingly, to join the multi-party MPC transaction, accountholders 122B and 122C use touchscreens of user computing devices 150B and 150C, respectively, to input the pattern required to join. Other haptic input methods may also be used. For example, joining a multi-party MPC transaction may require each of accountholders 122B and 122C to move user computing devices 150B and 150C, respectively, such that accelerometers (not shown) within user computing devices 150B and 150C register a particular movement pattern.

In still other embodiments, accountholders 122B and 122C use the MPC transaction application to access a list of pending multi-party MPC transactions. In certain embodiments, the list of pending multi-party MPC transactions is tailored to the particular accountholder. For example, the list of pending multi-party MPC transactions may be limited based on, without limitation, the accountholder's location, a list of “friends” of the accountholder, and a list of co-participants of prior multi-party MPC transactions. The MPC transaction application may further permit accountholders to search for pending multi-party MPC transactions, such as, by providing a MPC transaction identifier.

After each accountholder joins the multi-party MPC transaction, each accountholder is prompted to provide one or more payment card accounts to be charged as part of the MPC transaction and the portion of the MPC transaction amount to be charged to each payment card account. The portion of the payment transaction may include, without limitation, an absolute dollar amount, a relative dollar amount, a range of dollar amounts, an absolute percentage of the transaction total, a relative percentage of the transaction total, and a range of percentages of the transaction total. In certain embodiments, the MPC transaction application permits accountholders to participate in games and similar interactive activities to determine how the payment transaction is apportioned. For example, in one embodiment, the MPC application simulates a random event, such as a coin flip, on whose outcome the accountholders can wager to determine how much of the transaction each will pay.

After a multi-party MPC transaction is created and the participating accountholders have identified both the payment card accounts to be used for the purchase and the respective amounts to be charged to each payment card account, transaction requests are generated and transmitted to MPC transaction computing device 160. In certain embodiments, each accountholder transmits transaction requests corresponding to their own portion of the MPC transaction. In other embodiments, all relevant data is transmitted to a single user computing device, such as user computing device 150A of accountholder 122A, and consolidated into a single transaction request message that is sent to MPC transaction computing device.

In response to receiving the transaction requests, MPC transaction computing device 160 generates a VCN and creates a VCN record as described in the context of FIG. 1. The VCN is then sent to one or more of user computing devices 150A-C for presentation to merchant 124. For purposes of this discussion, MPC transaction computing device 160 transmits the VCN to accountholder 122A via user computing device 150A. The method of presenting the VCN to merchant 124 varies depending on the context of the multi-party MPC transaction. In online transactions, for example, accountholder 122A inputs the VCN as if it were a standard payment account card number. For in-person transactions, accountholder 122A can provide the VCN to merchant 124 in various ways. As a first example, accountholder 122A can read off the VCN to an employee of merchant 124 who then inputs the VCN into terminal 142. In a second example, accountholder 122A uses user computing device 150A to wirelessly transmit the VCN to terminal 142.

Merchant 124 then submits the payment transaction for processing as discussed above in the context of FIG. 1. More specifically, each subtransaction of the multi-party MPC transaction undergoes authorization, clearing, and settlement. During each of those transaction processes, and as described in more detail in the context of FIG. 1, MPC transaction computing device 160 facilitates processing of MPC transactions by converting between VCN-based messages and the individual messages required to process the subtransactions of the MPC transaction. For example, in embodiments in which authorization occurs when the MPC transaction is submitted by merchant 124 via merchant bank 126, MPC transaction computing device 160 receives a single authorization request message with the VCN from merchant bank 126. MPC transaction computing device 160 then generates individual authorization request message corresponding to the subtransactions associated with each of accountholders 122A, 122B, and 122C. MPC transaction computing device 160 then transmits the authorization request message to issuers 130A, 130B, and 130C, respectively. In response to receiving authorization response messages from each of issuers 130A, 130B, and 130C, MPC transaction computing device 160 generates a VCN authorization response message indicating the result of the authorization process and transmits the VCN authorization response message to merchant bank 126.

The subsequent processes of clearing and settlement are generally performed in the manner described in the context of FIG. 1. More specifically, during clearing, MPC transaction computing device 160 receives clearing request message from merchant bank 126 containing transaction data. MPC transaction computing device then generates individual clearing messages for each subtransaction of the MPC transaction and transmits the individual clearing messages to issuers 130A-C. During settlement, MPC transaction computing device 160 consolidates settlement messages and fund transfers from issuers 130A-C into one VCN settlement message and one fund transfer that are then transmitted to merchant bank 126.

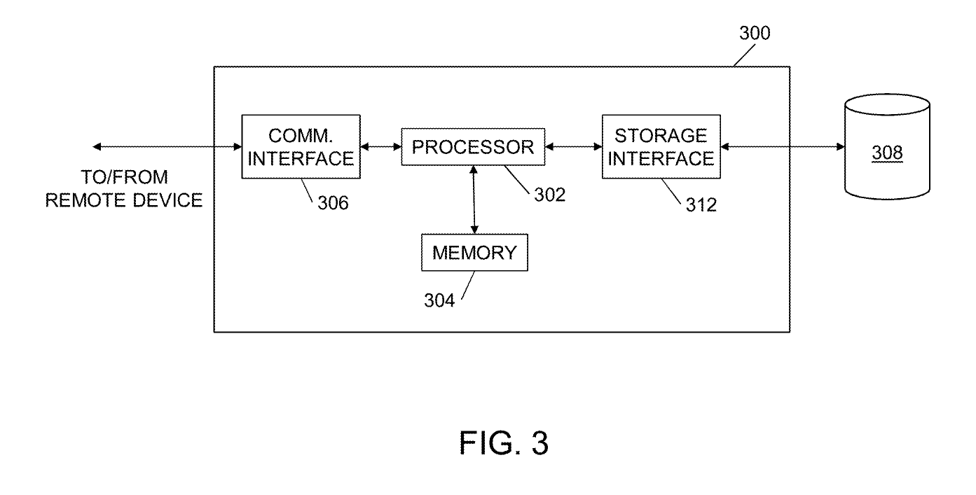

FIG. 3 is a schematic illustration of an example MPC transaction computing device 300, such as MPC transaction computing devices 60 and 160 (shown in FIGS. 1 and 2, respectively). In the exemplary embodiment, host computing device 300 includes a processor 302 for executing instructions. Instructions may be stored in a memory area 304, for example. Processor 302 may include one or more processing units (e.g., in a multi-core configuration) for executing instructions. The instructions may be executed within a variety of different operating systems on host computing device 300, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 302 is operatively coupled to a communication interface 306 such that MPC transaction computing device 300 is capable of communication with one or more remotes device including, but not limited to, external storage devices, client computing devices, user computing devices, interchange network computing devices, and other computing devices. Communication interface 306 may include, for example, a transceiver, a transmitter, a receiver, an Ethernet communication interface, an RS-485/EIA-485 communication interface, a GPM communications interface, a programmable logic controller, an RS-322 communication interface, and/or any other communication interface device and/or component.

Processor 302 may also be operatively coupled to one or more storage devices, including, data source 308. Storage devices may be any computer-operated hardware suitable for storing and/or retrieving data. In some embodiments, one or more storage devices, such as consumer data source 308, are integrated in host computing device 300. For example, consumer data source 308 and may include multiple storage units such as hard disks or solid state disks in a redundant array of inexpensive disks (RAID) configuration. Data storage devices may include a storage area network (SAN) and/or a network attached storage (NAS) system.

In some embodiments, processor 302 is operatively coupled to storage devices, such as data source 308, via a storage interface 312. Storage interface 312 is any component capable of providing processor 302 with access to a storage device. Storage interface 312 may include, for example, an Advanced Technology Attachment (ATA) adapter, a Serial ATA (SATA) adapter, a Small Computer System Interface (SCSI) adapter, a RAID controller, a SAN adapter, and/or any component providing processor 302 with access to a storage device. In certain embodiments, MPC transaction computing device 300 may be communicatively coupled to one or more storage devices, including data source 308, which are remote from MPC transaction computing device 300 but are accessible by MPC transaction computing device 300 through one or more of communication interface 306 and storage interface 312.

Memory area 304 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

MPC transaction computing device 300 is generally in communication with one or more user computing devices, such as user computing device 50 (shown in FIG. 1) and user computing devices 150A-C (shown in FIG. 2), and facilitates processing of MPC transactions.

During operation, MPC transaction computing device 300 receives two or more transaction request messages corresponding to an MPC transaction. In certain embodiments, each transaction request message is received separately and includes an MPC transaction identifier such that MPC transaction computing device 300 can identify transaction request messages associated with a particular MPC transaction. In other embodiments, each transaction request message is combined into a single MPC transaction message and transmitted by a user computing device to MPC transaction computing device 300. Each transaction request message generally includes an identifier corresponding to a payment card account and an amount to be charged to the payment card account. In response to receiving the transaction request messages, MPC transaction computing device 300 generates a virtual card number (VCN) for use in the MPC transaction and transmits the VCN to a user computing device associated with one of the payment card accounts.

For each VCN, MPC transaction computing device 300 generates and stores a VCN record, for example, in one of data source 308 and memory 304. Each VCN record correlates the generated VCN to the underlying payment card account numbers. In certain embodiments, the VCN record includes additional data including, without limitation, the amount or portion of the MPC transaction assigned to each payment card account, whether each payment card account has been authorized, a date and/or time stamp for the transaction, a merchant identifier, a note describing the purchase, and any relevant transaction data. In certain embodiments, the VCN is subject to one or more usage limitations to prevent unauthorized use of the VCN. To the extent such limitations are exceeded, the VCN is rendered void and unable to be used for a payment transaction. As a first example, the VCN is subject to a time limit such that the VCN becomes void after a predetermined period of time. As another example, the VCN becomes void if it is submitted by a merchant other than a merchant identified by the initiator of the MPC transaction. In still another example, the VCN becomes void if it is submitted for an amount that is different than originally provided by the transaction request messages.

MPC transaction computing device 300 facilitates the authorization, clearing, and settlement processes for a subsequent payment card transaction using the VCN. With respect to authorization, MPC transaction computing device 300 generates and submits authorization request messages for each subtransaction of the MPC transaction. MPC transaction computing device 300 then transmits each authorization request message to a corresponding issuing bank for authorization. In response to each authorization request message, MPC transaction computing device 300 receives an authorization confirmation message indicating whether the issuer approved or declined authorization.

In certain embodiments, MPC transaction computing device 300 pre-authorizes each subtransaction. More specifically, MPC transaction computing device 300 performs the authorization process prior to generating and/or transmitting the VCN. If an issuing bank declines one or more of the subtransactions, MPC transaction computing device 300 generates a decline message and transmits the decline message to one of the user computing devices. In certain embodiments, MPC transaction computing device 300 transmits a general decline message to the user computing device of the user who initiated the MPC transaction and a specific decline message to each user computing device of users associated with payment card accounts that were not authorized. If each subtransaction of the MPC transaction is authorized, MPC transaction computing device 300 generates and transmits a VCN to the initiating user computing device. When the VCN is subsequently submitted as part of a payment card transaction, MPC transaction computing device 300 generates an authorization response message without sending additional messages to the issuing banks and transmits the authorization response message to the acquirer/merchant bank.

In other embodiments, MPC transaction computing device 300 performs authorization when a merchant or merchant bank submits a payment card transaction using the generated VCN. In such embodiments, MPC transaction computing device 300 may first perform a lookup of VCN records to retrieve the relevant payment card transaction data and to generate corresponding authorization request messages. If each issuer authorizes its respective subtransactions, MPC transaction computing device transmits an authorization confirmation message to the acquirer/merchant bank. If, on the other hand, one or more issuers decline authorization, MPC transaction computing device 300 generates and transmits an authorization decline message to the acquirer/merchant bank and, in certain embodiments, to one or more of the user computing devices of those participating in the MPC transaction.

Following authorization, MPC transaction computing device 300 facilitates clearing of the MPC transaction. During clearing, MPC transaction computing device 300 receives a clearing request from a merchant bank. MPC transaction computing device 300 then generates individual clearing messages corresponding to each issuer implicated by the MPC transaction. Each clearing message includes only the relevant transaction data for the particular issuer to which it is being sent.

MPC transaction computing device 300 further facilitates settlement of MPC transactions. During settlement, MPC transaction computing device 300 receives settlement messages corresponding to each subtransaction of the MPC transaction. MPC transaction computing device 300 combines each settlement message into a single settlement message associated with the VCN and transmits the single settlement message to the acquirer/merchant bank.

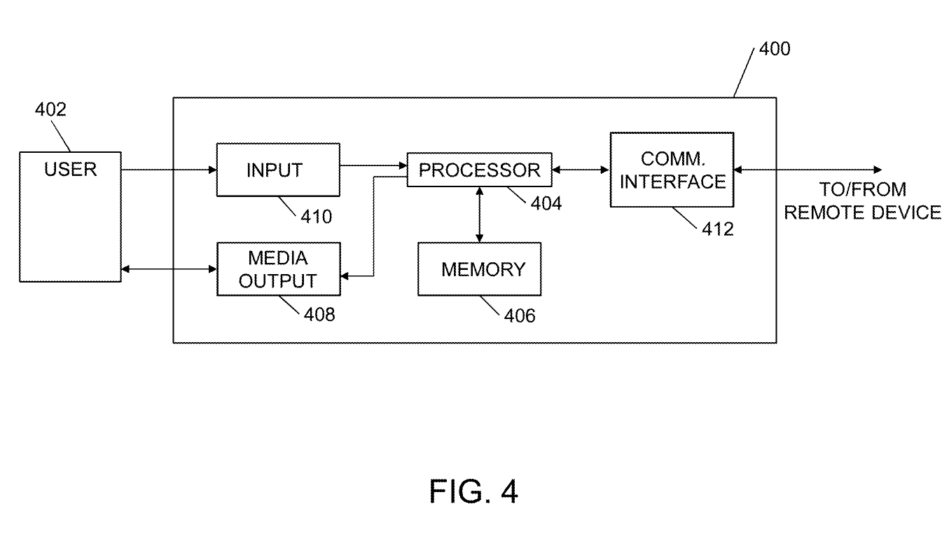

FIG. 4 is a schematic illustration of a user computer device 400, such as user computing devices 50 and 150A-C (shown in FIGS. 1 and 2, respectively). In the exemplary embodiment, user computer device 400 includes a processor 404 for executing instructions. In some embodiments, executable instructions are stored in a memory area 406. Processor 404 may include one or more processing units (e.g., in a multi-core configuration) for executing instructions. Memory area 406 is any device allowing information such as executable instructions and/or other data to be stored and retrieved. Memory area 406 may include one or more computer-readable media.

User computing device 400 may also include at least one media output component 408 for presenting information to a user 402. Media output component 408 may be any component capable of conveying information to user 402. For example, media output component 408 includes an output adapter such as an audio adapter and/or a video adapter. The output adapter is operatively coupled to processor 404 and operatively couplable to an output device such as an audio output device, such as a speaker or headphones, or a display device, such as a liquid crystal display, organic light emitting diode display, or “electronic ink” display. Stored in memory area 406 are, for example, computer readable instructions for providing a user interface to user 402 via media output component 408.

In certain embodiments, user computing device 400 includes an input device 410 for receiving input from user 402. Input device 410 may include, for example, an audio input device such as a microphone, a keyboard, a pointing device, a mouse, a stylus, a touch sensitive panel, a touch pad, a touch screed, a gyroscope, an accelerometer, or a position detector. A single component such as a touch screen may function as both an output device of media output component 408 and input device 410.

User computing device 400 may also include a communication interface 412 operatively coupled to processor 404 such that user computing device 400 facilitates communication with one or more remote devices including, but not limited to, external storage devices, client computing devices, and other computing devices. Communication interface 412 may include, for example, a wired or wireless network adapter or a wireless data transceiver for use with a mobile phone network such as GSM, 3G, 4G, or any other mobile data network or WIMAX.

Stored in memory area 406 are, for example, computer readable instructions for providing a user interface to user 402 via media output component 408, and optionally, receiving and processing input from input device 410. A user interface may include, among other possibilities, a web browser and client application. Web browsers enable users 402 to display and interact with media and other information typically embedded on a web page or website from a web server associated with the MPC transaction system, such as MPC transaction system 100 (shown in FIG. 1).

During operation, user computing device 400 permits user 402 to initiate an MPC transaction for example, via a MPC application stored in memory 406. Initiation of a MPC transaction generally involves providing basic transaction information including, without limitation, the amount of the transaction, the merchant to be paid, the products/services being purchased, and the like. In certain embodiments, user 402 manually inputs the transaction information using input 410. For example, user 402 may use a keyboard (physical or virtual), stylus, touchscreen, or similar input device to provide the transaction information. In certain embodiments, input 410 includes a camera, QR code reader, barcode reader, or similar optical device. In such embodiments, MPC application or user computing device 400 may be configured to read or convert (such as by performing optical character recognition) image data captured by the optical device and capture data therefrom. For example, in certain embodiments, user 402 takes a picture of a receipt and MPC application extracts the transaction information from the picture.

If the MPC transaction is a multi-party MPC transaction, user 402 opens the MPC transaction to other users of the MPC application. Alternatively, if the MPC transaction is a single user MPC transaction, user 402 proceeds to provide payment account information. In either case, each user participating in the MPC transaction provides one or more payment card accounts and assigns an amount to be charged to each provided account. Payment card account information may be provided in various ways. In a first example, users manually type in or otherwise provide payment account information. In another example, payment card account information is stored in a memory, such as memory 406, of a user computing device such that a user can select from the memory the payment card account information to use for the transaction. In still other embodiments, payment card account information is remotely stored in a digital wallet or similar repository and is accessed via a user computing device, such as by communications interface 412. To the extent providing payment account information includes retrieving stored data, a user may be required to provide authentication or other credentials including, without limitation, one or more of a username, a password, an answer to a security question, biometric data, a randomly generated key, a haptic input, and the like.

After user 402 provides the necessary payment card account information and assigns a portion of the transaction to be charged, a transaction request message is transmitted to a MPC transaction computing device, such as MPC transaction computing device 300 (shown in FIG. 3). In certain embodiments, each user computing device involved in a MPC transaction generates and transmits transaction requests messages corresponding to payment card accounts of the respective user. In other embodiments, each user computing device involved in the MPC transaction transmits a transaction request message to one user computing device, such as the initiating user computing device. The one user computing device then bundles all of the transaction request messages into one MPC transaction message and transmits the MPC transaction message to the MPC transaction computing device.

User computing device 400 is further configured to receive, from the MPC transaction computing device, a VCN. In certain embodiments, the VCN is received as a string of characters that is then presented to user 402 via media output 408. User 402 may then provide the VCN, for example by reading the VCN, to a merchant for payment. In other embodiments, user computing device 400 facilitates other methods of providing the VCN to a merchant. For example, in a first embodiment, MPC application generates a QR code or a barcode corresponding to the VCN that may be scanned by an optical input of a merchant computing device, such as a point-of-sale terminal. In another embodiment, user computing device 400 transmits the VCN over a short-range communications protocol, such as Bluetooth, to a merchant computing device. In still another embodiment, user computing device 400 generates an electromagnetic signal pattern corresponding to the VCN that, when received by a magnetic card reader, provides the VCN.

With respect to multi-party MPC transactions, user computing device 400 is further configured to facilitate coordination of multiple user computing devices to pay for a given transaction. More specifically, user computing device 400 is used either to invite other users to join a particular MPC transaction, to create a MPC transaction that other users may join, or to join an existing MPC transaction.

In certain embodiments, when user 402 initiates an MPC transaction, user 402 uses MPC transaction computing device 400 to generate and send invitations to one or more other users. Invitations may take the form of, without limitation, emails, text messages, SMS messages, in-app messages, and the like. Invitations may be sent over a network, such as network 152 (shown in FIG. 2) or may be transmitted using one or more short-range communications protocols. Invitations may include a link, a unique MPC transaction code, or other identifying information. Accordingly, to accept the invitation and join the MPC transaction, users may click the link, provide the MPC transaction code, or otherwise confirm participation in the MPC transaction. In certain embodiments, joining an MPC transaction includes providing a haptic gesture via input 410. For example, a user may be required to provide a specific swipe pattern on a touchscreen. In other embodiments, joining a MPC transaction requires provision of specific accelerometer data. Accordingly, a user must move their device in a specific predetermined way to join the MPC transaction. Similarly, joining an MPC transaction may require that users touch or otherwise bring their respective user computing devices into physical proximity with each other. In certain embodiments, if a user receives an invitation to join an MPC transaction and does not currently have the MPC application installed on their user computing device, the user may be automatically directed to a website, application store, or similar source to download the application to their user computing device.

In other embodiments, user 402 creates a MPC transaction that other users may join. For example, in certain embodiments the MPC application permits a user to see a list of current MPC transactions. The list of MPC transactions may be limited or filterable based on various parameters including, without limitation, physical proximity to the initiator of the MPC transaction, the merchant associated with the MPC transaction, whether the MPC transaction was initiated by a social media “friend” of the user, the date and/or time of the MPC transaction, and the like. In certain embodiments, a user can search the list of MPC transactions based on the various parameters. When a user finds the MPC transaction they wish to join, they may click or otherwise select the MPC transaction from the list and proceed with providing the necessary payment card account information. In certain instances, the user may also be required to provide credentials such as a pin number, password, haptic input, accelerometer input, or other input before being permitted to join the transaction.

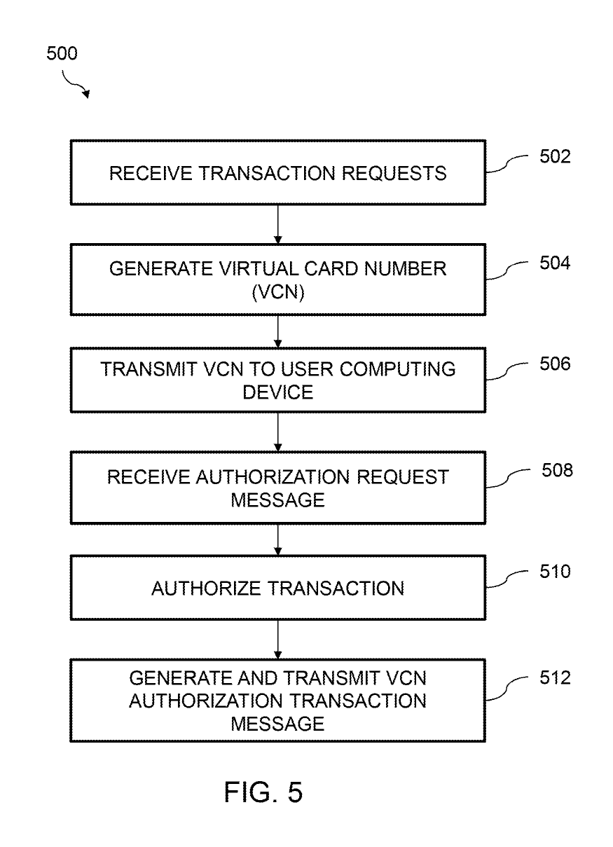

FIG. 5 is a diagram illustrating an example of a method 500 for processing a multi-account payment card (MPC) transaction performed by an MPC transaction computing device, such as MPC transaction computing device 300 of FIG. 3.

Method 500 includes receiving 502, at the MPC transaction computing device, multiple transactions requests from one or more user computing devices. Transaction requests are received by the MPC transaction computing device individually or, in certain embodiments, in collections of two or more transaction requests in an MPC transaction request message. Each transaction request generally includes at least a payment card account identifier and one of a dollar amount or portion of a MPC transaction to be charged to the payment card account.

In response to receiving the transaction requests, MPC transaction computing device generates a virtual card number (VCN) 504 corresponding to the MPC transaction. In certain embodiments, generation of the VCN further includes generating a VCN record that correlates the VCN to the underlying subtransactions of the MPC transaction. Accordingly, the MPC transaction computing device may perform lookups of the VCN record to determine the payment card accounts associated with the VCN and vice versa. The MPC transaction computing device then transmits the VCN 506 to one or more of the user computing devices.

Following generation of the VCN to the user computing device, the user provides the VCN to a merchant for use in processing the MPC transaction. More specifically, the merchant submits a payment card transaction to an interchange network using the VCN as the payment card account number. In general, processing of a payment card transaction includes an authorization process in which an issuing bank is queried to determine whether the payment card account has sufficient funds and is otherwise approved for the payment card transaction. In the case of MPC transactions, the merchant or merchant bank submits an authorization request including the VCN and total charge. The MPC transaction computing device receives the authorization request 508 and proceeds to authorize the transaction 510.

To authorize the transaction, the MPC transaction computing device may perform a lookup of the VCN record to determine the payment card accounts implicated in the MPC transaction and the corresponding amounts to be charged to each payment card account. The MPC transaction computing device then generates individual authorization requests for each subtransaction of the MPC transaction and transmits the individual authorization requests to corresponding issuing banks. Upon receipt of authorization confirmation messages from each issuing bank, the MPC transaction computing device generates a consolidated authorization confirmation message and transmits the consolidated authorization message 512 to the merchant and/or merchant bank.

In certain embodiments, the MPC transaction computing device pre-authorizes each MPC transaction. Pre-authorization generally refers to authorization that occurs prior to submission of an authorization request by the merchant and/or merchant bank and, more specifically, before generation and transmission of the VCN. In a pre-authorization process, MPC transaction computing device performs the steps of authorization after receiving the transaction requests. When the merchant and/or merchant bank subsequently submits an authorization request corresponding to the MPC transaction, the MPC transaction computing device automatically generates and transmits an authorization request message without reauthorizing the subtransactions of the MPC transaction.

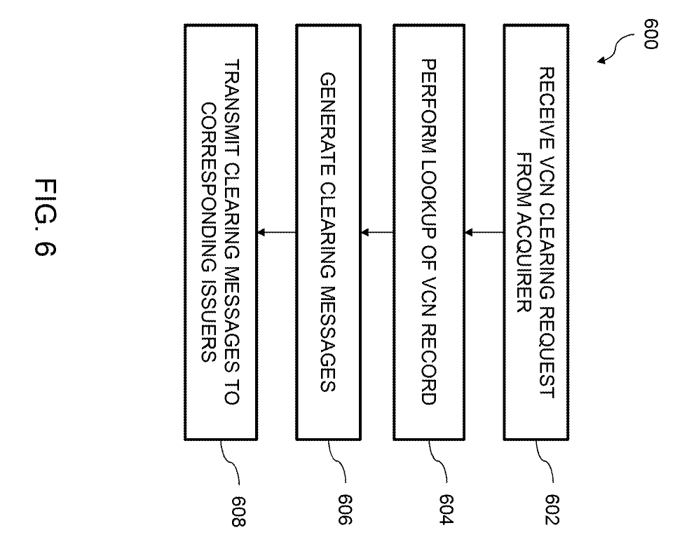

FIG. 6 is a diagram illustrating an example of a method 600 for processing an MPC transaction performed by an MPC transaction computing device, such as MPC transaction computing device 300 of FIG. 3. More specifically, method 600 is directed to performing clearing of MPC transactions.

At step 602, the MPC transaction computing device receives a clearing request from an acquirer/merchant bank. In general, the clearing request includes a VCN previously provided by the MPC transaction computing device to a user and provided by the user to a merchant during the initial payment process. In response to receiving the clearing request, the MPC transaction computing device performs a lookup of the VCN 604 to identify the payment card accounts associated with the VCN. Once identified, the MPC transaction computing device generates individual clearing messages 606 for each payment card account implicated in the MPC transaction. The clearing messages are then transmitted to the corresponding issuers 608 to complete the clearing process.

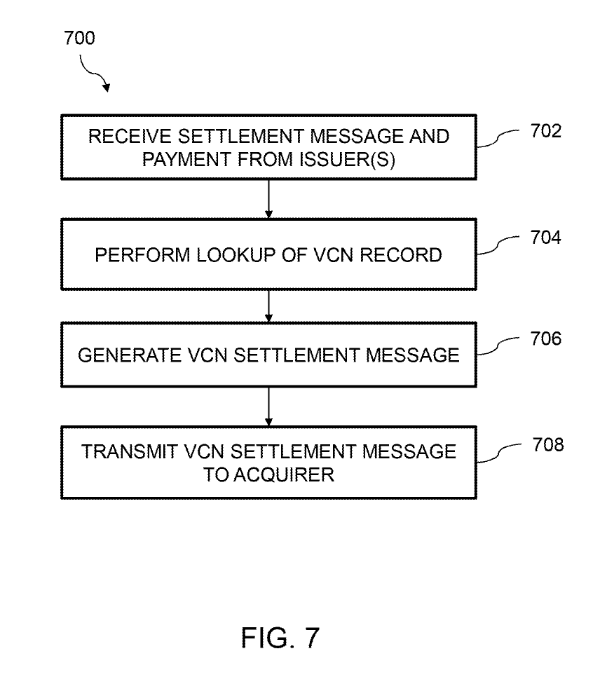

FIG. 7 is a diagram illustrating an example of a method 700 for processing an MPC transaction performed by an MPC transaction computing device, such as MPC transaction computing device 300 of FIG. 3. More specifically, method 700 is directed to performing settlement of MPC transactions.

At step 702, the MPC transaction computing device receives one or more settlement messages from issuers associated with an MPC transaction. Each settlement message corresponds to a subtransaction of the MPC transaction and may further include a fund transfer. In response to receiving a settlement message and/or fund transfer from an issuer, MPC transaction computing device performs VCN record lookup 704 to identify the MPC transaction associated with the settlement request. When the MPC transaction computing device has received settlement messages and/or fund transfers for each subtransaction of the MPC transaction, the MPC transaction computing device consolidates the received settlement messages into a single VCN settlement message and single fund transfer 706 that is then transmitted to the acquirer/merchant bank 708 associated with the MPC transaction.

### Additional Considerations

The computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the terms “card,” “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transaction card can be used as a method of payment for performing a transaction. In addition, consumer card account behavior can include, but is not limited to, purchases, management activities (e.g., balance checking), bill payments, achievement of targets (meeting account balance goals, paying bills on time), and/or product registrations (e.g., mobile application downloads).

For example, one or more computer-readable storage media may include computer-executable instructions embodied thereon for performing MPC transaction processing. In this example, the computing device may include a memory device and a processor in communication with the memory device, and when executed by said processor, the computer-executable instructions may cause the processor to perform a method, such as the methods described and illustrated in the examples of FIGS. 6-7.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example, the system is executed on a single computer system, without a connection to a server computer. In a further example, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional examples that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A multi-account payment card (MPC) transaction computing device comprising one or more processors in communication with one or more memory devices, said MPC transaction computing device configured to:
receive a first transaction request including a first identifier corresponding to a first payment card account and a first portion of a payment transaction initiated with a merchant using the first payment card account;
receive a second transaction request including a second identifier corresponding to a second payment card account and a second portion of the payment transaction for payment using the second payment card account;
generate a virtual card number (VCN) corresponding to the payment transaction, wherein generating the VCN includes generating a VCN record correlating the VCN to each of the first payment card account and the second payment card account;
transmit the VCN to a user computing device of an accountholder of one of the first payment card account and the second payment card account;
initiate authorization of the payment transaction including requesting authorization of the first payment card account for the first portion of the payment transaction and requesting authorization of the second payment card account for the second portion of the payment transaction;
generate a VCN authorization confirmation message; and
transmit the VCN authorization confirmation message to the merchant.

2. The MPC transaction computing device in accordance with claim 1, wherein when initiating authorization of the payment transaction, the MPC transaction computing device is further configured to:
transmit a first authorization request message to a first issuer corresponding to the first payment card account and a second authorization request message to a second issuer corresponding to the second payment card account; and
receive, from the first issuer, a first authorization confirmation message corresponding to the first authorization request message and, from the second issuer, a second authorization confirmation message corresponding to the second authorization request message.

3. The MPC transaction computing device in accordance with claim 2, wherein transmitting the first authorization request message and the second authorization request message is in response to one of: (i) receiving, from the merchant, an authorization request including the VCN; and (ii) receiving the first transaction request and the second transaction request.

4. The MPC transaction computing device in accordance with claim 1, wherein the MPC transaction computing device is further configured to:
receive a VCN clearing request from an acquiring bank associated with the merchant, the clearing request including the VCN;
generate a first clearing message corresponding to the first payment card account and a second clearing message corresponding to the second payment card account; and
transmit the first clearing message to a first issuer and the second clearing message to a second issuer.

5. The MPC transaction computing device in accordance with claim 1, wherein the MPC transaction computing device is further configured to:
receive a first settlement message from a first issuer associated with the first payment card account and a second settlement message from a second issuer associated with the second payment card account;
consolidate the first settlement message and the second settlement message into a VCN settlement message including the VCN; and
transmit the VCN settlement message to an acquirer associated with the merchant.

6. The MPC transaction computing device in accordance with claim 1, wherein at least one of the first portion of the payment transaction and the second portion of the payment transaction is one of: (i) a fixed dollar amount; (ii) a range of dollar amounts; (iii) a fixed percentage of the payment transaction; and (iv) a range of percentages of the payment transaction.

7. The MPC transaction computing device in accordance with claim 1, wherein the payment transaction is a multi-party payment transaction such that the first payment card account is associated with a first accountholder and the second payment card account is associated with a second accountholder different from the first accountholder.

8. The MPC transaction computing device in accordance with claim 7, wherein the first accountholder initiates the multi-party payment transaction using a first user computing device and the second accountholder joins the multi-party payment transaction using a second user computing device, wherein the second user joins the multi-party payment transaction by performing at least one of: (i) accepting an invitation message from the first user computing device; (ii) selecting the multi-party payment transaction from a list of multi-party payment transactions displayed on the second user computing device; (iii) transmitting haptic input data to the first user computing device, the haptic input data corresponding to a predetermined gesture that is predetermined by the first user; (iv) transmitting accelerometer data to the first user computing device, the accelerometer data corresponding to a predetermined movement of the second user computing device; and (v) transmitting credentials to the first user computing device over a short-range communications protocol.

9. A computer-implemented method for performing multi-account payment card (MPC) transactions, the method being implemented by a MPC transaction computing device, the method comprising:
receiving, at the MPC transaction computing device, a first transaction request including a first identifier corresponding to a first payment card account and a first portion of a payment transaction initiated with a merchant using the first payment card account;
receiving, at the MPC transaction computing device, a second transaction request including a second identifier corresponding to a second payment card account and a second portion of the payment transaction for payment using the second payment card account;
generating a virtual card number (VCN) corresponding to the payment transaction, wherein generating the VCN includes generating a VCN record correlating the VCN to each of the first payment card account and the second payment card account;
transmitting the VCN to a user computing device of an accountholder of one of the first payment card account and the second payment card account;
initiating authorization of the payment transaction including requesting authorization of the first payment card account for the first portion of the payment transaction and requesting authorization of the second payment card account for the second portion of the payment transaction;
generating a VCN authorization confirmation message; and
transmitting the VCN authorization confirmation message to the merchant.

10. The method in accordance with claim 9, wherein initiating authorization of the payment transaction further comprises:
transmitting a first authorization request message to a first issuer corresponding to the first payment card account and a second authorization request message to a second issuer corresponding to the second payment card account; and
receiving, from the first issuer, a first authorization confirmation message corresponding to the first authorization request message and, from the second issuer, a second authorization confirmation message corresponding to the second authorization request message.

11. The method in accordance with claim 10, wherein transmitting the first authorization request message and the second authorization request message is in response to one of: (i) receiving, from the merchant, an authorization request including the VCN; and (ii) receiving the first transaction request and the second transaction request.

12. The method in accordance with claim 9, further comprising:
receiving a VCN clearing request from an acquiring bank associated with the merchant, the clearing request including the VCN;
generating a first clearing message corresponding to the first payment card account and a second clearing message corresponding to the second payment card account; and
transmitting the first clearing message to a first issuer and the second clearing message to a second issuer.

13. The method in accordance with claim 9, further comprising:
receiving a first settlement message from a first issuer associated with the first payment card account and a second settlement message from a second issuer associated with the second payment card account;
consolidating the first settlement message and the second settlement message into a VCN settlement message including the VCN; and
transmitting the VCN settlement message to an acquirer associated with the merchant.

14. The method in accordance with claim 9, wherein at least one of the first portion of the payment transaction and the second portion of the payment transaction is one of: (i) a fixed dollar amount; (ii) a range of dollar amounts; (iii) a fixed percentage of the payment transaction; and (iv) a range of percentages of the payment transaction.

15. The method in accordance with claim 9, wherein the payment transaction is a multi-party payment transaction such that the first payment card account is associated with a first accountholder and the second payment card account is associated with a second accountholder different from the first accountholder.

16. The method in accordance with claim 15, wherein the first accountholder initiates the multi-party payment transaction using a first user computing device and the second accountholder joins the multi-party payment transaction using a second user computing device, wherein the second user joins the multi-party payment transaction by performing at least one of: (i) accepting an invitation message from the first user computing device; (ii) selecting the multi-party payment transaction from a list of multi-party payment transactions displayed on the second user computing device; (iii) transmitting haptic input data to the first user computing device, the haptic input data corresponding to a predetermined gesture that is predetermined by the first user; (iv) transmitting accelerometer data to the first user computing device, the accelerometer data corresponding to a predetermined movement of the second user computing device; and (v) transmitting credentials to the first user computing device over a short-range communications protocol.

17. A non-transitory computer readable medium that includes computer executable instructions for facilitating processing of multi-account payment card (MPC) transactions, wherein when executed by a MPC transaction computing device comprising at least one processor in communication with at least one memory device, the computer executable instructions cause the MPC transaction computing device to:
receive a first transaction request including a first identifier corresponding to a first payment card account and a first portion of a payment transaction initiated with a merchant using the first payment card account;
receive a second transaction request including a second identifier corresponding to a second payment card account and a second portion of the payment transaction for payment using the second payment card account;
generate a virtual card number (VCN) corresponding to the payment transaction, wherein generating the VCN includes generating a VCN record correlating the VCN to each of the first payment card account and the second payment card account;
transmit the VCN to a user computing device of an accountholder of one of the first payment card account and the second payment card account;
initiate authorization of the payment transaction including requesting authorization of the first payment card account for the first portion of the payment transaction and requesting authorization of the second payment card account for the second portion of the payment transaction;
generate a VCN authorization confirmation message; and
transmit the VCN authorization confirmation message to the merchant.

18. The non-transitory computer readable medium of claim 17, wherein the computer executable instructions further cause the MPC transaction computing device to:
receive a VCN clearing request from an acquiring bank associated with the merchant, the clearing request including the VCN;
generate a first clearing message corresponding to the first payment card account and a second clearing message corresponding to the second payment card account; and
transmit the first clearing message to a first issuer and the second clearing message to a second issuer.

19. The non-transitory computer readable medium of claim 17, wherein the computer executable instructions further cause the MPC transaction computing device to:
receive a first settlement message from a first issuer associated with the first payment card account and a second settlement message from a second issuer associated with the second payment card account;
consolidate the first settlement message and the second settlement message into a VCN settlement message including the VCN; and
transmit the VCN settlement message to an acquirer associated with the merchant.

20. The non-transitory computer readable medium of claim 17, wherein the payment transaction is a multi-party payment transaction such that the first payment card account is associated with a first accountholder and the second payment card account is associated with a second accountholder different from the first accountholder.
